(19) United States
(12) Patent Application Publication
(10) Pub. No.: US 2022/0018374 A1
(43) Pub. Date: Jan. 20, 2022

(54) INCREMENTALLY ADJUSTABLE RIVET FIXTURE

(71) Applicant: Brandon Ghanma, San Jose, CA (US)

(72) Inventor: Brandon Ghanma, San Jose, CA (US)

(21) Appl. No.: 16/933,918

(22) Filed: Jul. 20, 2020

(51) Int. Cl. F16B 19/08

(52) U.S. Cl. CPC F16B 19/08

(57) ABSTRACT

The invention is an incrementally adjustable rivet fixture used to join two or more items of varying thickness.

### TECHNICAL FIELD

The invention is a system for joining items together with a rivet fixture that is incrementally adjustable.

### BACKGROUND OF INVENTION

Items with holes through them may be joined in many ways. A screw can be extended through each hole and a nut applied to hold the items together, for example. A paper fastener can extend through a hole in multiple sheets of paper after which the bendable appendages are bent so as to join the multiple sheets of paper. A rivet fixture made with two mating portions can be placed on either side of the hole, while an insertion shaft on one portion of the rivet fixture is inserted into a receiving shaft on the other portion. In the latter case, the width between the head of one portion and the base of the other portion is fixed by its structure. If the width of the items to be joined is wider than that of the joined rivet fixture, it will not be able to be locked; and if the width of the items is significantly narrower than that of the joined rivet fixture, it will cause the junction to be loosely joined.

### BRIEF DESCRIPTION OF INVENTION

The invention herein disclosed and claimed is a rivet fixture in which the insertion shaft of one portion has incremental detents allowing incremental adjustment of the width of the joined fixture portions. This enables the rivet fixture to form a tight joint of multiple items where the width of the items may vary over a fixed limit determined by the structure of the rivet fixture and the number of detents and the distance between them.

### BRIEF DESCRIPTION OF DRAWINGS

FIG. 1 shows the two portions of the rivet fixture wherein one has an insertion shaft with two or more external detent sub-structures and the other portion has a receiving shaft with a fixed internal detent substructure.

FIG. 2 illustrates the same rivet fixture can be incrementally used with items wherein the width of the items to be joined may be essentially that shown in A where a last detent is locked in place; or B where the width may be that where a second detent is locked in place; or C where the width may be that where a first detent is locked in place.

FIG. 3 illustrates an example of a first portion having an insertion shaft with two or more external detents, and provides dimensions proportional to the diameter of its head substructure.

FIG. 4 illustrates a top and bottom view of the rivet fixture portion of FIG. 3, as oriented in FIG. 3.

FIG. 5 illustrates the other portion of the rivet fixture wherein a receiving shaft has an internal detent substructure fixed in position; and provides dimensions proportional to the diameter of its base portion.

FIG. 6 illustrates a top and bottom view of the rivet fixture of FIG. 5, as oriented in FIG. 5.

FIG. 7 illustrates another embodiment of FIG. 5 wherein an internal detent substructure is segmented.

### DETAILED DESCRIPTION OF INVENTION

The invention herein disclosed and claimed is a rivet fixture used to join items together using a hole in each item. The rivet fixture comprises two portions: one has a circular head substructure and an insertion shaft whose axis is perpendicular to the plane of the head substructure and which is centered with the center of the head substructure.

The mating portion of the rivet fixture has a base which is essentially a mirror image of the head when the two portions are joined. It has a receiving shaft whose axis is perpendicular to the plane of the base and is centered with the center of the base portion.

When the first portion's insertion shaft is inserted into the second portion's receiving shaft, a joint is formed wherein the two shafts extend through the hole of each item to be joined, and the head and base form end pieces that apply pressure to the items keeping them joined.

The key to keeping the two rivet fixtures tightly joined is having an external detent substructure on the insertion shaft that locks with an internal detent substructure on the receiving shaft. These detent substructures are circular and coaxial when joined. The detent structure on the insertion shaft has a chamfered surface wherein the substructure narrows in the direction away from the head substructure and has a flat surface facing the head substructure; and the receiving shaft has a similar circular internal substructure wherein the chamfered surface widens in the direction away from the base substructure, and has a flat surface facing the base substructure.

When the insertion shaft is inserted into the receiving shaft, the chamfered surfaces flex inward toward the axis permitting the detent on the insertion shaft to move past the detent of the receiving shaft. However, if the direction of insertion is reversed, that is, if the two portions are pulled away from each other, the flat portions of both detents now abut with one another preventing them from moving away from one another. Essentially, the two portions of the rivet fixture are locked from being separated.

If more than one detent substructure is molded or machined on the insertion shaft of the one portion of the rivet fixture, and placed concentric with other detents but positioned at some other axial position, these more than one detents provide an incrementally adjustable rivet fixture wherein the length of the conjoined shafts can be locked at different lengths depending upon the spacing between the insertion shaft detents. As such, the distance between the head and base substructures can be incrementally adjusted.

In use, when items are to be joined, the items are aligned such that their respective holes are concentric. With the rivet fixture portion having the insertion shaft placed on one side of the items, and the rivet fixture portion having the receiving shaft placed on the opposite side of the items, the insertion shaft is inserted through one hole, and the receiving shaft is inserted through the opposite hole, and the head and base substructures are moved with pressure toward one another until they can no longer continue being compressed. When the pressure is release, the two portions will now be locked together by their respective detent structures wherein the flat surfaces of each abut against one another.

Where the items to be joined are thick, the two rivet fixture portions may only come together to a first detent position. Where the items are thinner, the two rivet fixture portions may come together past a first-detent position and become locked into another detent position. Essentially, the width of the joined rivet fixture portions, when locked, is incrementally adjustable.

Adjustable widths are determined by the length of the insertion shaft of the one portion, and the number and pitch of its external detent substructures.

The following is meant to further describe the invention and structures.

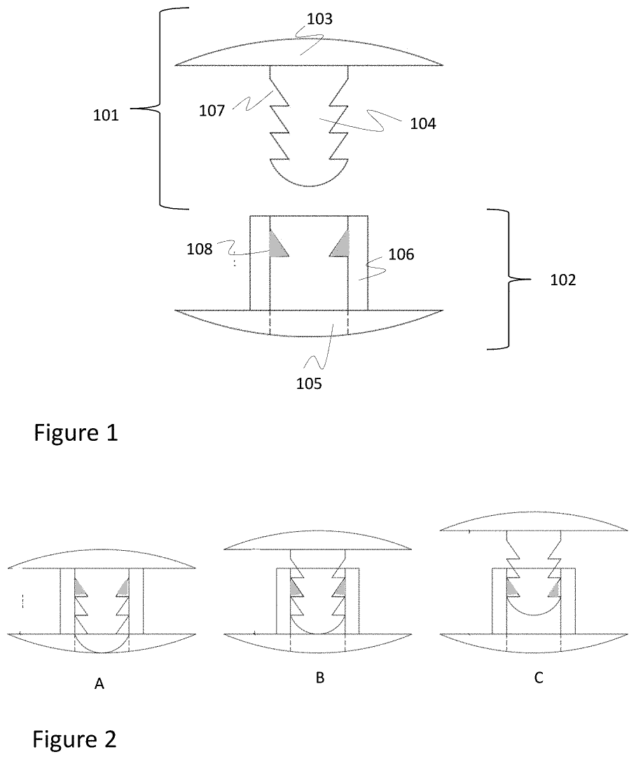

In FIG. 1, a side view, the one rivet fixture portion (101) comprises a head (103) and insertion shaft (104). One external detent (107) is denoted whereas there are three detent substructures. The side view of the other rivet fixture portion (102) shows it base (105) and receiving shaft (106). Its single, fixed, internal detent substructure (108) is shaded.

In FIG. 2, view A, the two portions of the rivet fixture are joined and locked in position by the detent structure closest to the head. As such, it will have a minimum width between head and base. In view B, the two portions are locked by the second detent substructure and will therefore have a wider space between head and base. In view C, the two portions are locked by the detent structure furthest from the head. As a result, the width between head and base will be the widest. It should be noted that if the items to be joined have a width greater than that of view C, the two portions would be unable to lock. In that case, a longer insertion shaft would be required.

Figure three shows one embodiment of one portion (101) of the rivet fixture. The head has a diameter of D. All other dimensions are proportions of D. The length of the insertion shaft shown (302) is essentially D/2.25. The thickness of the head substructure is essentially D/10. The diameter of the insertion shaft is essentially D/4, and the smaller diameter of the detent substructures is essentially 2D/3. In this exemplary case, there are three detent substructures that are separated by essentially D/10 distance along the insertion shaft. As such, the incremental change in width is essentially D/10, and the number of adjustable positions is three.

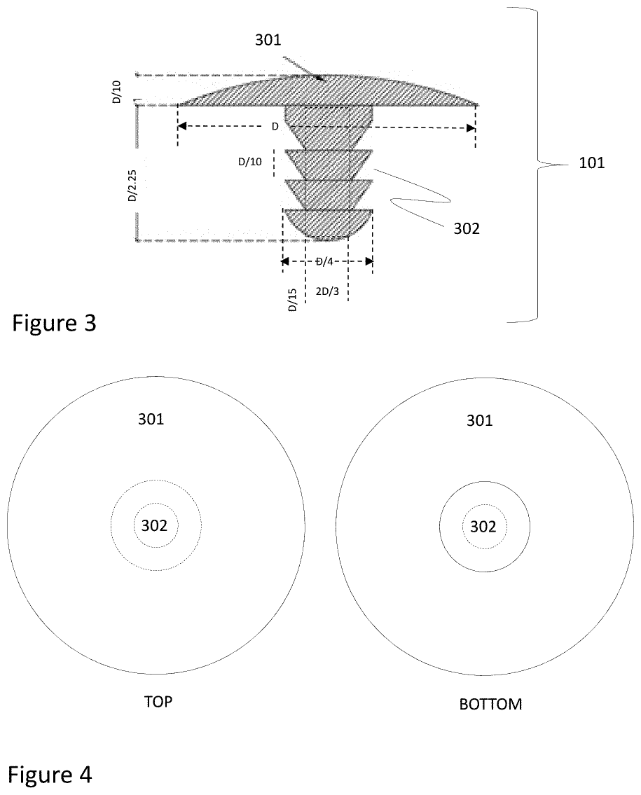

FIG. 4 shows top and bottom views of the rivet fixture portion of FIG. 3 oriented as shown in FIG. 3.

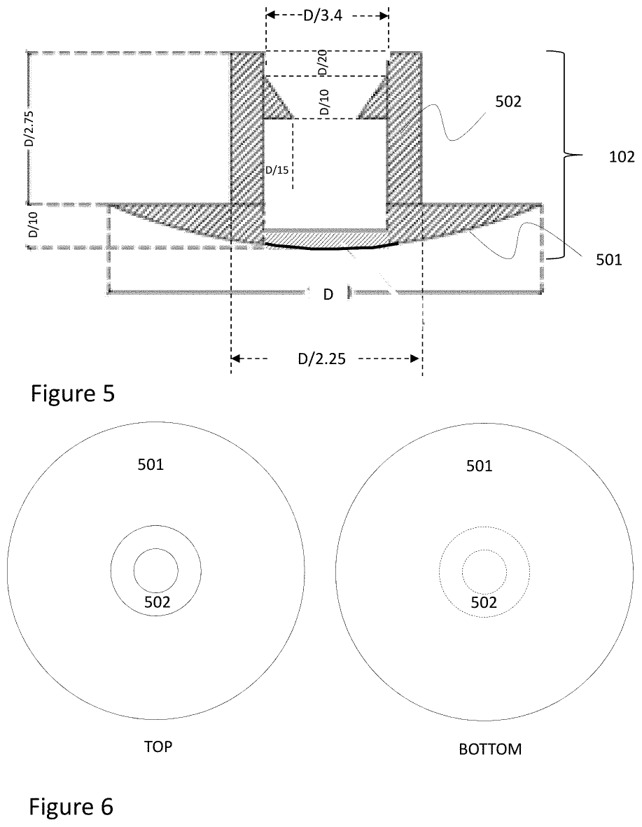

FIG. 5 is an example side view of the other portion of the rivet fixture with a base (501) that forms a mirror image of the head when joined with the portion from FIG. 3. The length of the receiving shaft (502) is essentially D/2.75. The outer diameter of the shaft is essentially D/2.25 and inner diameter is essentially D/3.4. The internal detent structure is fixed in position down essentially D/20 from the upper edge of the shaft.

FIG. 6 shows top and bottom views of the portion in FIG. 5 oriented as shown in FIG. 5.

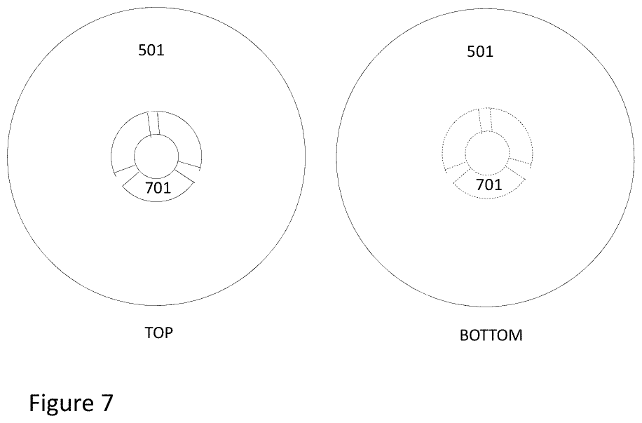

FIG. 7 shows another embodiment of the rivet fixture portion wherein the receiving shaft has an internal detent structure that is segmented (701) rather than a continuous circular substructure. This may permit the insertion shaft to more easily pass the receiving shaft's detent substructure due to greater flexibility when the two rivet fixture portions are pressed toward one another. At the same time, when the portions are attempted to be pulled apart, this segmented internal detent structure could still provide adequate locking.

The rivet fixture can be made of plastic, metal, and whereas the dimensions are not critical, the diameter of head and base should be chosen to be larger than the largest hole in the items to be joined. In addition, the material should be sufficiently flexible to allow the detent substructure on the insertion shaft to move past the detent structure of the receiving shaft, yet rigid enough to prevent two locked portions to be easily pulled apart. Consequently, materials should be chosen based on anticipated worst-case forces anticipated in a direction that would pull the two portions apart. The invention herein disclosed and claimed could have a head/base diameter restricted to a range of 8 to 20 mm. Within that range, the dimensional proportions may be preserved without compromising functional operation.

The figures represent an example of the invention and should not be read as limiting the invention to specific dimensions or materials.

What is claimed is:

1. An incrementally adjustable rivet fixture comprising:
a head substructure;
an insertion shaft substructure;
said insertion shaft substructure is concentric with said head substructure and its axis is perpendicular to the orientation plane of said head substructure; and
said insertion shaft substructure comprises two or more external detent circular substructures, concentric with said head substructure, with a diameter greater than that of said insertion shaft substructure, displaced from one another along the shaft, and a chamfered surface on the side facing away from said head structure, and a flat surface coplanar with and facing said head substructure.

2. An incrementally adjustable rivet fixture comprising:
a base substructure;
a receiving shaft substructure;
said receiving shaft substructure is concentric with said base substructure and its axis is perpendicular to the orientation plane of said base substructure; and
said receiving shaft substructure comprises an internal detent circular substructure, concentric with said base substructure, with a diameter smaller than the diameter of said receiving shaft substructure's inner diameter, and a chamfered surface on the side facing away from said base structure, and a flat surface coplanar with and facing said base substructure.

3. An incrementally adjustable rivet fixture comprising:
said base substructure;
said receiving shaft substructure;
said receiving shaft substructure is concentric with said base substructure and its axis is perpendicular to the orientation plane of said base substructure;
said receiving shaft substructure comprises an internal detent circular substructure, concentric with said base substructure, with a diameter smaller than the diameter of said receiving shaft substructure's inner diameter, and a chamfered surface on the side facing away from said base structure, and a flat surface coplanar with and facing said base substructure; and
said internal detent circular substructure is segmented rather than a continuous circular structure comprising two or more segments.

4. A claim as in claim 1 further comprising:
said diameter of said insertion shaft is essentially 2D/3 that of said head substructure of diameter D; and said diameter of said two or more circular detent structures is essentially ¼ that of said diameter, D, of said head substructure.

5. A claim as in claim 1 further comprising:
distance between successive said external circular detent structures is essentially one-tenth of said diameter, D, of said head substructure.

6. A claim as in claim 2 further comprising:
external diameter of said receiving shaft is essentially one-quarter that of said diameter, D, of said base substructure.

7. A claim as in claim 3 further comprising:
said external diameter of said receiving shaft is essentially one-quarter that of said diameter, D, of said base substructure.

8. A claim as in claim 1 further comprising:
said diameter, D, of said head substructure has a length which may be a value between 8 and 20 millimeters.

9. A claim as in claim 2 further comprising:
said diameter, D, of said base substructure has a length which may be a value between 8 and 20 millimeters.

10. A claim as in claim 3 further comprising:
said diameter, D, of said base substructure has a length which may be a value between 8 and 20 millimeters.
